(19) United States
(12) Patent Application Publication
(10) Pub. No.: US 2016/0014388 A1
(43) Pub. Date: Jan. 14, 2016

(54) ELECTRONIC DEVICE, METHOD, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventor: Takahiro TAKIMOTO, Sayama Saitama (JP)

(21) Appl. No.: 14/601,727

(22) Filed: Jan. 21, 2015

(30) Foreign Application Priority Data
Jul. 11, 2014 (JP) 2014-143512

(51) Int. Cl. H04N 13/00

(52) U.S. Cl. CPC H04N 13/0025; H04N 13/004; H04N 13/0029

(57) ABSTRACT

According to one embodiment, an electronic device includes a receiver and circuitry. The receiver is configured to receive a first operation input via a user interface by a user. The first operation is for specifying positions of each of a plurality of parallax images as a tubular surface position. The circuitry is configured to perform tubular surface correction on each of the parallax images with reference to positions of the parallax images specified as a tubular surface position.

### CROSS-REFERENCE TO RELATED APPLICATIONS

This application is based upon and claims the benefit of priority from Japanese Patent Application No. 2014-143512, filed Jul. 11, 2014, the entire contents of which are incorporated herein by reference.

### FIELD

Embodiments described herein relate generally to an electronic device, a method, and a computer program product for generating a multi-parallax image.

### BACKGROUND

Capturing a three-dimensional stereoscopic image requires a stereoscopic image capturing system that uses two or more cameras.

When the stereoscopic image capturing system is built by a multi-parallax camera which uses commercially available general-purpose cameras, the respective cameras need to be adjusted (calibrated) to obtain a stereoscopic image with no unnatural impression.

When a stereoscopic image is created, it is required to specify a position of the image that is to be set as a tubular surface (position where parallax is zero) at which the image is displayed, after capturing the image.

However, if camera calibration is performed by using a conversion matrix and/or the like, an image may be distorted and a stereoscopic view might be affected thereby.

Further, it has been desired to be able to freely specify the tubular surface (position where parallax is zero in the image) in accordance with image capturing conditions.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a schematic configuration of an image processing system according to an embodiment;

FIG. 2 is an exemplary block diagram of a schematic configuration of an electronic device, in the embodiment;

FIG. 3 is an exemplary flowchart of processing of the electronic device in the embodiment;

FIGS. 4A to 4C are exemplary explanatory diagrams of for when enlargement ratios of images are adjusted, in the embodiment;

FIG. 5 is an exemplary explanatory diagram of adjustment based on an enlargement ratio, in the embodiment; and

FIGS. 6A and 6B are exemplary explanatory diagrams of a feature quantity matching process, in the embodiment.

### DETAILED DESCRIPTION

In general, according to one embodiment, an electronic device comprises a receiver and circuitry. The receiver is configured to receive a first operation input via a user interface by a user. The first operation is for specifying positions of each of a plurality of parallax images as a tubular surface position. The circuitry is configured to perform tubular surface correction on each of the parallax images with reference to positions of the parallax images specified as a tubular surface position.

An embodiment will be described in detail with reference to the accompanying drawings.

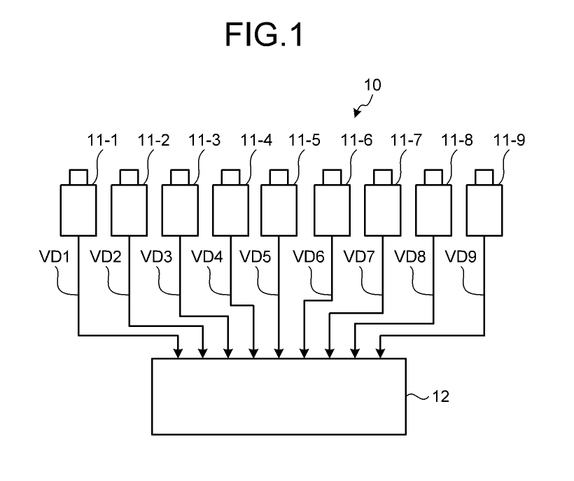

FIG. 1 is a block diagram of a schematic configuration of an image processing system according to the embodiment.

An image processing system 10 is a system that creates a stereoscopic image using a parallel viewing method. The image processing system 10 comprises a plurality of (nine in FIG. 1) video cameras 11-1 to 11-9 and an electronic device 12. The video cameras 11-1 to 11-9 have optical axes of lenses spaced at constant distances therebetween, and are adjusted so that the optical axes are oriented in the same direction. The electronic device 12 receives video data (photograph data) VD1 to VD9 output from the respective video cameras 11-1 to 11-9, and performs image processing to generate and output multi-parallax image data.

The processing of generating the multi-parallax image data is described in detail, for example, in Japanese Patent Application Laid-open No. 2013-070267, so that detailed description thereof will be omitted.

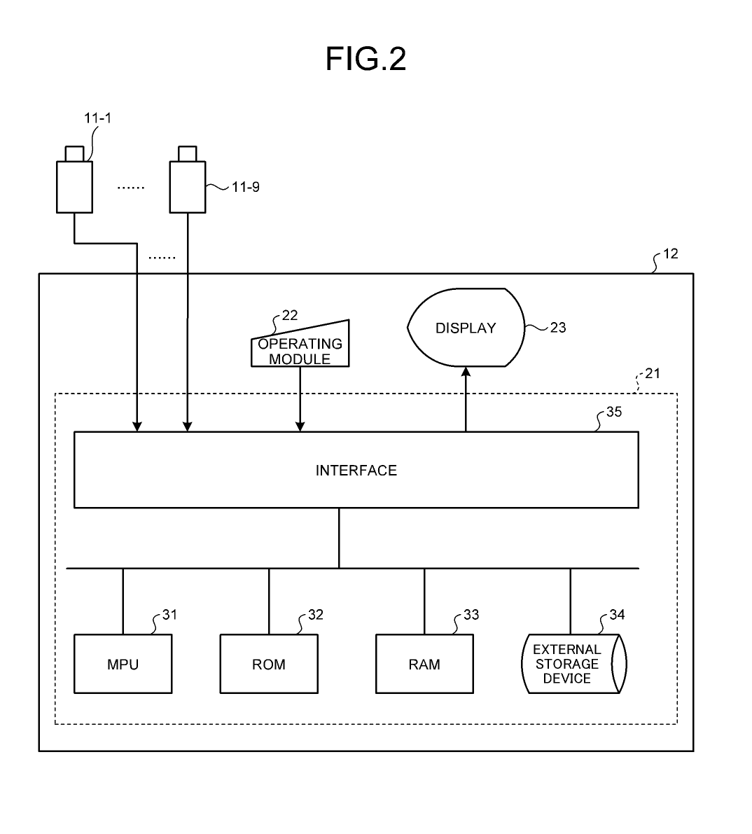

FIG. 2 is a block diagram of a schematic configuration of the electronic device.

The electronic device 12 comprises a processing device main body 21, an operating portion 22, and a display 23. The processing device main body 21 generates the multi-parallax image data based on the received video data VD1 to VD9. The operating portion 22 is configured as a keyboard, a mouse, a tablet, and the like on which an operator performs various operations. The display 23 can display a generation processing screen and the generated multi-parallax image data.

The processing device main body 21 is configured as what is called a microcomputer, and comprises a microprocessor unit (MPU) 31, a read-only memory (ROM) 32, a random access memory (RAM) 33, an external storage device 34, and an interface 35. The MPU 31 controls the entire electronic device 12. The ROM 32 stores various types of data, including computer programs, in a nonvolatile manner. The RAM 33 is also used as a working area of the MPU 31 and temporarily stores the various types of data. The external storage device 34 is configured as, for example, a hard disk drive or a solid state drive (SSD). The interface 35 performs interface operations between, for example, the video cameras 11-1 to 11-9, the display 23, and the operating portion 22.

An operation of the embodiment will be described.

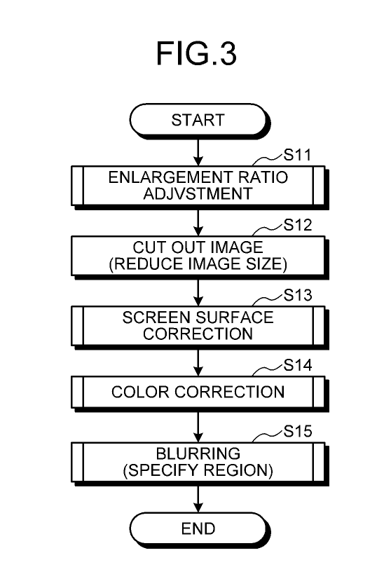

FIG. 3 is a flowchart of a processing of the electronic device of the embodiment.

First, an enlargement ratio of each of the images corresponding to the video data VD1 to VD9 output from the respective video cameras 11-1 to 11-9 are adjusted (S11).

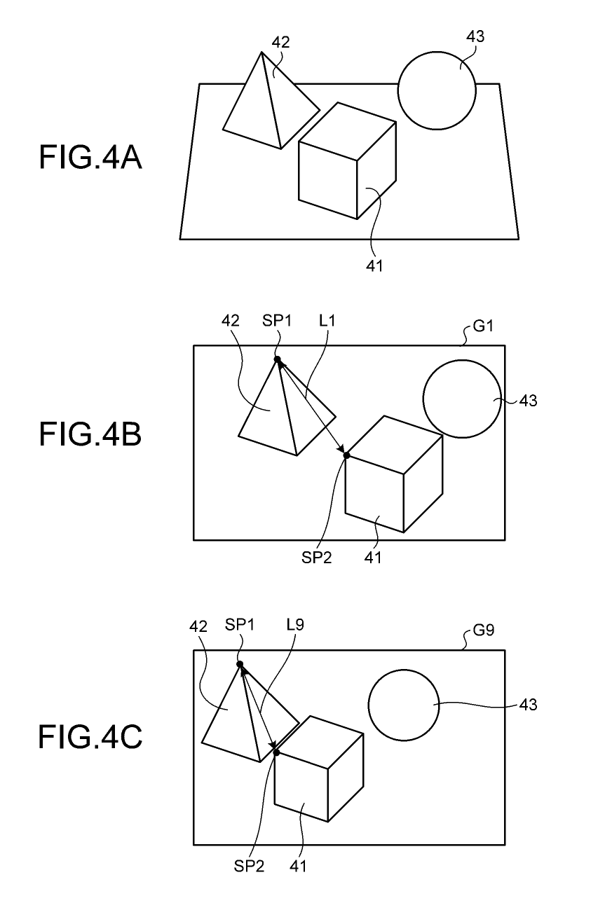

FIGS. 4A to 4C are explanatory diagrams of the operations when the enlargement ratios of the images are adjusted.

FIG. 4A illustrates an example of an object, and illustrates a cubic object 41, a quadrangular pyramid object 42, and a spherical object 43.

Each of FIGS. 4B and 4C illustrates an example of an image of the objects of FIG. 4A. FIG. 4B illustrates, for example, an image G1 obtained by the video camera 11-1, and FIG. 4C illustrates, for example, an image G9 obtained the video camera 11-9.

To adjust the enlargement ratio of each of the images, the operator first specifies two feature points SP1 and SP2 that are recognized as identical between the images illustrated in FIGS. 4B and 4C (second operation).

This causes the MPU 31 to calculate a distance L in each of the images (distances L1 and L9 in FIGS. 4B and 4C) between the feature points SP1 and SP2 as illustrated in FIGS. 4B and 4C, for example.

Specifically, for a nine-parallax image, the distances between respective pairs of feature points SP1 and SP2 of a set of parallax images composed of nine images G1 to G9 are denoted as L1, L2, . . . , L8, and L9.

The maximum distance of the distances L1 to L9 is denoted as Lmax.

Values obtained by dividing each of the distances L1 and L9 by the distance Lmax is denoted as enlargement ratios ER1 to ER9, respectively.

Specifically, the following are obtained.

$$ER 1 = L max / L 1$$

$$ER 2 = L max / L 2$$

$$… \qquad … \qquad …$$

$$ER 8 = L max / L 8$$

$$ER 9 = L max / L 9$$

The images G1 to G9 are enlarged at the respectively corresponding enlargement ratios ER1 to ER9.

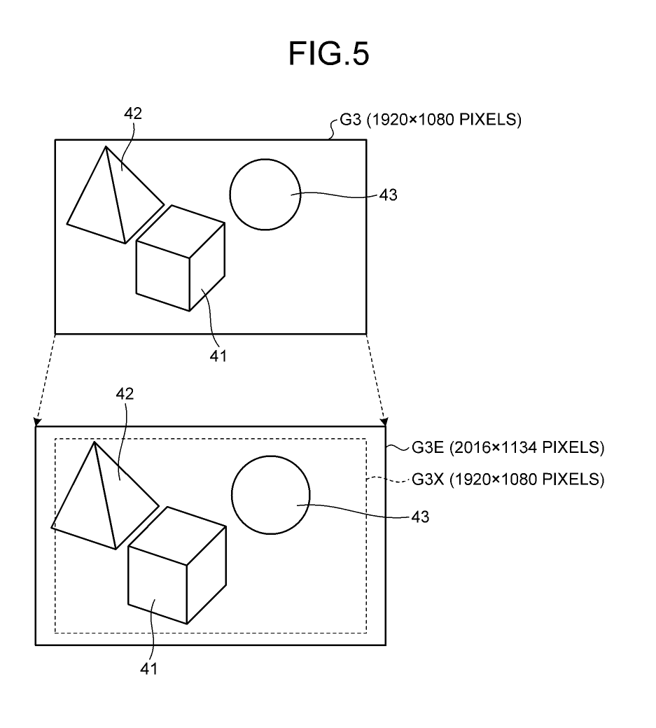

FIG. 5 is an explanatory diagram of adjustment based on the enlargement ratio.

The adjustment based on the enlargement ratio will be described with reference to FIG. 5.

For example, the image G3 is enlarged at the enlargement ratio ER3 as described above to generate an enlarged image G3E. More specifically, if the image G3 has a resolution of 1920 pixels×1080 pixels, and the enlargement ratio ER3=1.05, the resolution of the enlarged image G3E obtained is 2016 pixels×1134 pixels, as illustrated in FIG. 5.

Then, an image having a resolution equal to the original resolution of 1920 pixels×1080 pixels is made as a post-enlargement ratio adjustment image G3X. In this case, the post-enlargement ratio adjustment image G3X is cut out from the center portion of the enlarged image G3E (S12).

In the same manner, enlarged images G1E, G2E, and G4E to G9E corresponding to images G1, G2, and G4 to G9, respectively, are generated, and the cutout is performed to obtain post-enlargement ratio adjustment images G1X, G2X, and G4X to G9X.

The above description has assumed that the image resolutions of the images cut out are equal to the original image resolutions because the image resolutions (image sizes) of the images G1 to G9 as original images are eventually the same as the image resolutions (image sizes) of the images for generating the multi-parallax image. However, the image resolutions after the cutout can be appropriately set according to the number of parallaxes.

Next, tubular surface correction is performed by using the post-enlargement ratio adjustment images G1X to G9X (S13).

In the tubular surface correction, a feature quantity matching process is performed by comparing a target image with a reference image.

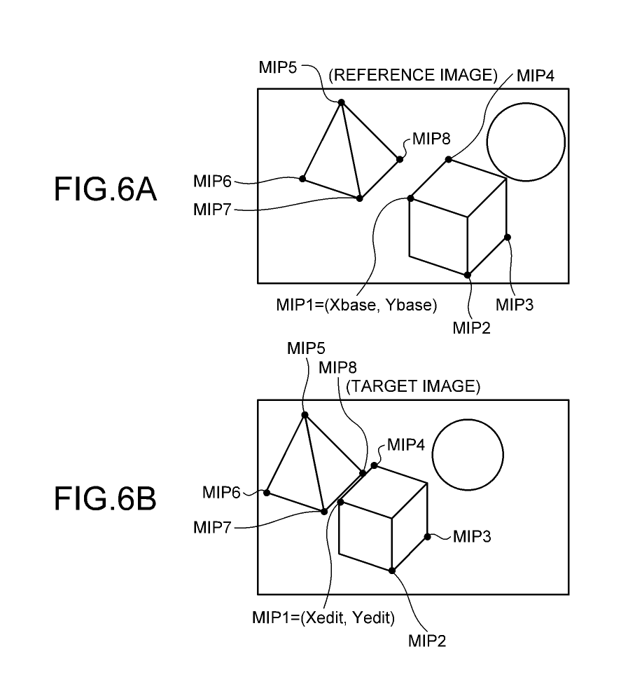

FIGS. 6A and 6B are explanatory diagrams of the feature quantity matching process.

First, from the feature points constituting the objects in the post-enlargement ratio adjustment images G1X to G9X, a matching feature point is extracted. Here, the matching feature point is a feature point that can be regarded as the same point (same portion) of the object among the post-enlargement ratio adjustment images G1X to G9X. Then, the extracted matching feature point is presented to the operator.

A plurality of such matching feature points are normally presented. Hence, the operator specifies any one of the matching feature points to be set as a tubular surface (where parallax is zero) (first operation).

For example, in the case of FIGS. 6A and 6B, eight matching feature points MIP1 to MIP8 are presented, and the operator specifies the matching feature point MIP1.

Then, a displacement (displacement in the x-direction and the y-direction) of the post-enlargement ratio adjustment image (target image) relative to the post-enlargement ratio adjustment image serving as a reference (reference image) is calculated. Consequently, regarding the matching feature point (the matching feature point MIP1 in the above-described example) specified by the operator, the display position of the target image illustrated in FIG. 6B (actually, the display position(s) of one or more such target images) is matched with the display position of the reference image illustrated in FIG. 6A on the display screen of the display 23.

More specifically, because the post-enlargement ratio adjustment images G1X to G9X have the same size as the original images, the matching feature points in the reference image are generally displayed at different coordinates from those of the matching feature points in the target image.

Hence, the calculation is performed so as to determine an amount of movement of the target image in the x-direction and the y-direction in order to match the matching feature points while keeping the reference image fixed, after placing the reference image and the target image on top of each other and the outlines of the images thereof are matched with each other in the x-y plane.

Specifically, denoting the movement amount in the x-direction as Move_x, the movement amount in the y-direction as Move_y, the coordinates of the matching feature point of the reference image as (Xbase, Ybase), and the coordinates of the matching feature point of the target image as (Xedit, Yedit), the following expressions are obtained.

Move₁₃ x=Xbase−Xedit Move_y=Ybase−Yedit

Performing the tubular surface correction in this manner allows the parallelism among the respective video cameras 11-1 to 11-9 to be automatically adjusted at the same time as the tubular surface correction.

Then, a color histogram in the reference image is obtained, and color correction is performed by performing histogram matching (color histogram correction) so as to approximate the color histogram of the target image to the color histogram of the reference image (S14).

Here, when the multi-parallax image is acquired at outdoors, for example, sometimes there exists a region in which crosstalk occurs wherever the tubular surface is set. Viewers feel unnatural at the three-dimensional appearance of the image in such a region.

Therefore, if such a region is generated, the operator specifies the region (third operation), and applies blurring processing with respect to the region (S15). Specifically, the operator uses a blurring effect to blur the region.

As described above, even if the stereoscopic image capturing system is built by using a plurality of general-purpose video cameras that are different in, for example, angle of view and tinge of color, the present embodiment can easily perform the parallelism adjustment and the tubular surface correction, thereby it becomes capable of generating natural stereoscopic images.

According to the tubular surface correction explained in the above embodiment, the feature quantity matching is used to selectably present the same image positions among the parallax images corresponding to the video data VD1 to VD9 that have been output from the video cameras 11-1 to 11-9, respectively. However, the operator manually specifies the same image positions among the parallax images corresponding to the respective video data VD1 to VD9.

In the above description, the operator specifies the crosstalk region. However, if the same feature points of the parallax images on which the tubular surface correction is performed are separated from each other by a predetermined distance or more, the region can automatically be determined as a region in which viewers feel unnatural at the three-dimensional appearance, and the blurring processing can automatically be applied to the region.

In the above description, the stereoscopic image capturing system is built by using the nine video cameras. However, any number of video cameras can be used if more than one video camera is used.

While the above description has been made of the case of using the video cameras as cameras, the system can be built by using digital cameras that can capture static images. In this case, the system can generate a stereoscopic image from the static images, or can be configured to connect the static images to use them as a pseudo-animation.

A computer program to be executed by the electronic device of the present embodiment is provided by being recorded as files in an installable or an executable format in a computer-readable recording medium or media, such as one or more CD-ROMs, flexible disks (FDs), CD-Rs, or digital versatile discs (DVDs).

The computer program to be executed by the electronic device of the present embodiment may be stored on a computer connected to a network, such as the Internet, and may be provided by being downloaded via the network. The computer program to be executed by the electronic device of the present embodiment may be provided or delivered via a network, such as the Internet.

The computer program for the electronic device of the present embodiment may be provided by being installed in advance in a ROM or the like.

The computer program to be executed by the electronic device of the present embodiment is configured in modules comprising the above-described modules (such as an input module and a processing module). As actual hardware, the MPU (processor) reads the computer program from the above-mentioned recording medium or media to execute the computer program, so that the above-described modules are loaded in a main memory, and the input module and the processing module are generated in the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to receive a first operation input via a user interface by a user, the first operation for specifying positions of each of a plurality of parallax images as a tubular surface position; and
circuitry configured to perform tubular surface correction on each of the parallax images with reference to positions of the parallax images specified as a tubular surface position.

2. The electronic device of claim 1, wherein the circuitry is configured to adjust an enlargement ratio of each of the parallax images so that dimensions of same objects in the parallax images become same.

3. The electronic device of claim 2, wherein
the receiver is configured to receive a second operation input via a user interface by a user, the second operation for specifying a pair of reference points of each of the parallax images; and
the circuitry is configured to adjust an enlargement ratio so that distances between pairs of reference points in the parallax images become same length.

4. The electronic device of claim 1, wherein
the receiver is configured to receive a third operation for specifying a region in the multi-parallax image generated after the tubular surface correction; and
the circuitry is configured to perform blurring processing to the specified region in the multi-parallax image generated after the tubular surface correction.

5. The electronic device of claim 1, wherein the processing circuitry is configured to process to display a candidate matching feature point of each of parallax images for selecting the tubular surface position.

6. An image processing method executed by an electronic device, the image processing method comprising:
receiving a first operation input via a user interface by a user, the first operation for specifying positions of each of a plurality of parallax images as a tubular surface position; and
performing tubular surface correction on each of the parallax images with reference to positions of the parallax images specified as a tubular surface position.

7. The image processing method of claim 6, wherein the performing comprises adjusting an enlargement ratio of each of the parallax images so that dimensions of the same objects in the parallax images become same.

8. The image processing method of claim 7, further comprising
receiving a second operation input via a user interface by a user, the second operation for specifying a pair of reference points of each of the parallax images; and
the performing comprises adjusting an enlargement ratio so that distances between pairs of reference points in the parallax images become same length.

9. The image processing method of claim 6, further comprising:
receiving a third operation for specifying a region in the multi-parallax image generated after the tubular surface correction; and
performing blurring processing to the specified region in the multi-parallax image generated after the tubular surface correction.

10. The image processing method of claim 6, further comprising displaying a candidate matching feature point of each of the parallax images for selecting the tubular surface position.

11. A computer program product having a non-transitory computer readable medium including programmed instructions for controlling an electronic device, wherein the instructions, when executed by a computer, cause the computer to perform:
receiving a first operation input via a user interface by a user, the first operation for specifying positions of each of a plurality of parallax images as a tubular surface position; and
performing tubular surface correction on each of the parallax images with reference to positions of the parallax images specified as a tubular surface position.

12. The computer program product of claim 11, wherein the performing comprises adjusting an enlargement ratio of each of the parallax images so that dimensions of the same objects in the parallax images become same.

13. The computer program product of claim 12, wherein the instructions, when executed by the computer, further cause the computer to perform receiving a second operation input via a user interface by a user, the second operation for specifying a pair of reference points of each of the parallax images, and
the performing comprises adjusting an enlargement ratio so that distances between pairs of reference points in the parallax images become same length.

14. The computer program product of claim 11, wherein the instructions, when executed by the computer, further cause the computer to perform:
receiving a third operation for specifying a region in the multi-parallax image generated after the tubular surface correction; and
performing blurring processing to the specified region in the multi-parallax image generated after the tubular surface correction.

15. The computer program product of claim 11, wherein the instructions, when executed by the computer, further cause the computer to perform displaying a candidate matching feature point of each of the parallax images for selecting the tubular surface position.
